(19) United States
(12) Patent Application Publication
(10) Pub. No.: US 2004/0201861 A1
(43) Pub. Date: Oct. 14, 2004

(54) Management technique of setting information for image formation apparatus

(75) Inventors: Osamu Ishibashi, Nagano-ken (JP); Kazuhiro Ichikawa, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/680,437

(22) Filed: Oct. 8, 2003

(30) Foreign Application Priority Data
Oct. 20, 2002 (JP) 2002-294764

(51) Int. Cl. G03G 15/00; G06F 15/00; G06F 3/12; H04N 1/29

(52) U.S. Cl. 358/1.1; 399/12; 358/300; 358/406; 399/119

(57) ABSTRACT

A setting information management device 20 is designed to acquire setting information of a color laser printer from a storage element 50 of a toner cartridge 40 set on a cartridge connector unit 28, register the acquired setting information into a setting information database 27, and output setting information retrieved among the registered setting information and an entry of a printer ID as a destination of copy to the storage element 50 of the toner cartridge 40. This arrangement effectively ensures easy setting of an image formation apparatus and enables settings of the image formation apparatus to be readily copied.

### BACKGROUND OF THE INVENTION

1. Field of the Invention

The present invention relates to a setting information management device for an image formation apparatus, and a corresponding method as well as an image formation apparatus.

2. Description of the Prior Art

Some known image formation apparatuses, such as printers and photocopiers, utilize switches disposed on a toner cartridge or a storage medium to set a toner saving mode or an energy saving mode or to effectuate another setting (see, for example, Patent Laid-Open Gazette No. 2002-2069). This prior art technique sets in advance the switches of the toner cartridge to effectuate the user's desired settings and causes the desired settings to be automatically reflected on the image formation apparatus when the toner cartridge is attached to the image formation apparatus.

In the case of replacement of an image formation apparatus, for example, by purchase, the same user generally requires the same settings in a new image formation apparatus. The prior art image formation apparatus, however, requires the user to operate an operation panel of the image formation apparatus or a computer connecting with the image formation apparatus, in order to effectuate setting of the new image formation apparatus. The user may also be required to set the switches of the toner cartridge for reflection of the desired settings

### SUMMARY OF THE INVENTION

The object of the invention is thus to provide a setting information management device for an image formation apparatus, a corresponding management method, and a corresponding image formation apparatus that ensure easy setting of the image formation apparatus. The object of the invention is also to provide a setting information management device for an image formation apparatus, a corresponding management method, and a corresponding image formation apparatus that enable settings of the image formation apparatus to be readily copied.

In order to achieve at least a part of the aforementioned objects, the setting information management device, the corresponding setting information management method and the image formation apparatus of the present invention are constructed as follows.

A setting information management device of the present invention is a device that manages setting information of an image formation apparatus, which writes the setting information into a storage element of a recording material cartridge detachably and replaceably attached to the image formation apparatus, the setting information management device including: an information acquisition module that acquires information including the setting information from the storage element of the recording material cartridge; and an information output module that outputs reflecting information to a storage element of a recording material cartridge, which is attachable to another image formation apparatus of an identical model or a different model with or from the model of the image formation apparatus, based on the acquired setting information, where the reflecting information is used to reflect settings of the image formation apparatus on the another image formation apparatus of the identical model or the different model.

The setting information management device of the invention outputs the information, which is used to reflect the settings of one image formation apparatus on another image formation apparatus of an identical model or a different model, to the storage element of the recording material cartridge, based on the setting information of the one image formation apparatus acquired from the storage element of the recording material cartridge. This arrangement effectively ensures easy setting of the image formation apparatus and enables the settings of the image formation apparatus to be readily copied. When the image formation apparatus is a color laser printer or a color photocopier, the recording material is toner and the recording material cartridge is a toner cartridge. When the image formation apparatus is a color ink jet printer, the recording material is ink and the recording material cartridge is an ink cartridge. The setting information may include at least one of network setting information, feeder setting information, resolution information, and toner saving mode information. The reflecting information may represent the setting information acquired by the information acquisition module. The reflecting information may further represent a program executed to reflect the settings of the image formation apparatus on the another image formation apparatus of the identical model or the different model.

In the setting information management device of the invention, as one aspect, the information output module may output identification information, which identifies the another image formation apparatus of the identical model or the different model, in addition to the reflecting information, and the reflecting information may be used to reflect the settings of the image formation apparatus, when the recording material cartridge with the storage element, to which the reflecting information has been output, is attached to the another image formation apparatus identified by the identification information.

An image formation apparatus of the present invention is an apparatus that forms an image on a recording medium, such as paper, with a recording material filled in a recording material cartridge detachably and replaceably attached to the image formation apparatus, the image formation apparatus including: an information reading module that reads out information stored in a storage element of the recording material cartridge, when the recording material cartridge is attached to the image formation apparatus; and a setting update module that, when the read-out information includes setting update information used to update settings of the image formation apparatus, updates the settings of the image formation apparatus, based on the setting update information.

When the information read from the storage element of the recording material cartridge includes the setting update information, which is used to update the settings of the image formation apparatus, the image formation apparatus of the invention updates the settings of the image formation apparatus, based on the setting update information. This arrangement ensures easy setting of the image formation apparatus. Here, the setting update information may represent information used to update at least one of settings including a network setting, a feeder setting, a resolution, and a toner saving mode.

In the image formation apparatus of the invention, as one aspect, the setting update information may include, as a piece of information, identification information of an image formation apparatus, which is an object of update of its settings, and the setting update module may update the settings of the image formation apparatus based on the setting update information, when the identification information included in the setting update information is identical with the identification information of the image formation apparatus. The image formation apparatus of the invention may further include an information writing module that writes the settings of the image formation apparatus as the setting update information into the storage element of the recording material cartridge.

The technique of the present invention is not restricted to the setting information management device and the image formation apparatus described above, but is also applicable to a setting information management method with the setting information management device.

### BRIEF DESCRIPTION OF THE DRAWINGS

FIG. 1 schematically illustrates the construction of a setting information management device 20 in one embodiment;

FIG. 2 is a block diagram of functional blocks showing electrical connection of the setting information management device 20;

FIG. 3 shows the appearance of the toner cartridge 40;

FIG. 4 schematically illustrates the structure of the color laser printer 60 in the embodiment;

FIG. 5 is a block diagram showing functional blocks of the controller 70;

FIG. 6 shows one example of the information stored in the storage element 50;

FIG. 7 is a flowchart showing a setting information acquisition routine;

FIG. 8 shows one example of the information managed in the setting information database 27;

FIG. 9 is a flowchart showing a setting information output routine;

FIG. 10 shows one example of the setting information retrieval window 150;

FIG. 11 shows one example of the printer ID entry window 160; and

FIG. 12 is a flowchart showing a setting information reading routine.

### DESCRIPTION OF THE PREFERRED EMBODIMENTS

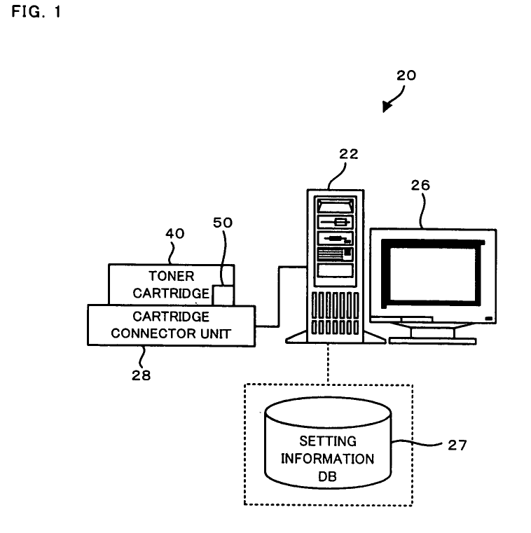

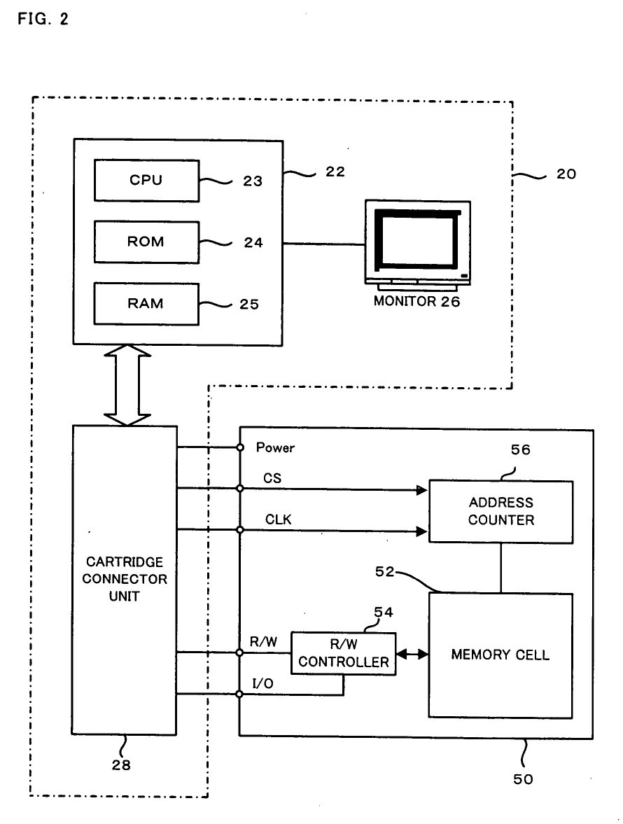

A preferred embodiment of the invention is discussed below. FIG. 1 schematically illustrates the construction of a setting information management device 20 to manage setting information of a color laser printer 60 in one embodiment of the invention. FIG. 2 is a block diagram of functional blocks showing electrical connection of the setting information management device 20 of the embodiment. As shown in FIGS. 1 and 2, the setting information management device 20 of the embodiment includes a general-purpose computer main frame 22 that has a CPU 23, a ROM 24, a RAM 25, and a non-illustrated input-output interface, a monitor 26 that connects with the computer main frame 22, a setting information database 27 that is installed in the computer main frame 22, and a cartridge connector unit 28 that is connected to the computer main frame 22 via the non-illustrated input-output terminal and receives a toner cartridge 40 mounted thereon. The setting information management device 20 reads setting information of the color laser printer 60, to which the toner cartridge 40 has been attached before collection, from a storage element 50 of the collected toner cartridge 40 set on the cartridge connector unit 28 and registers the setting information into the setting information database 27, so as to manage the setting information of the color laser printer 60.

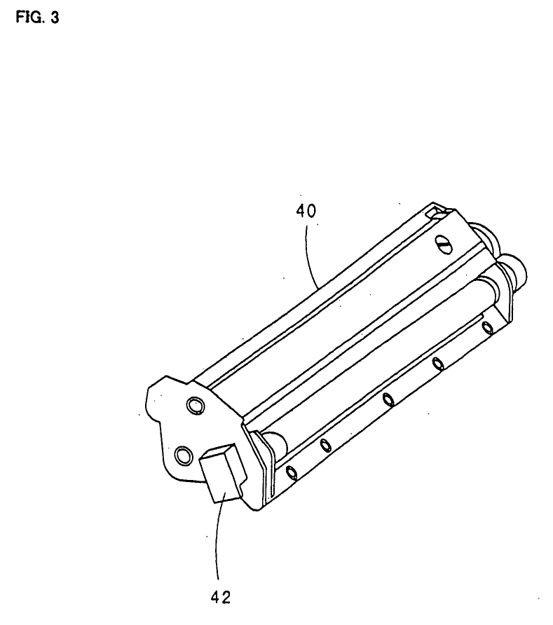

As shown in FIG. 2, the storage element 50 has a memory cell 52 that stores data therein, a read-write controller 54 that controls operations of reading and writing data from and into the memory cell 52, and an address counter 56 that counts up in the process of data transmission with the setting information management device 20 of the embodiment and the color laser printer 60 of the embodiment via the read-write controller 54 in response to a clock signal CLK. A typical example of the storage element 50 is an EEPROM. FIG. 3 shows the appearance of the toner cartridge 40. The toner cartridge 40 of the embodiment has the storage element 50 disposed inside a holder 42 located on one end of the toner cartridge 40, as illustrated.

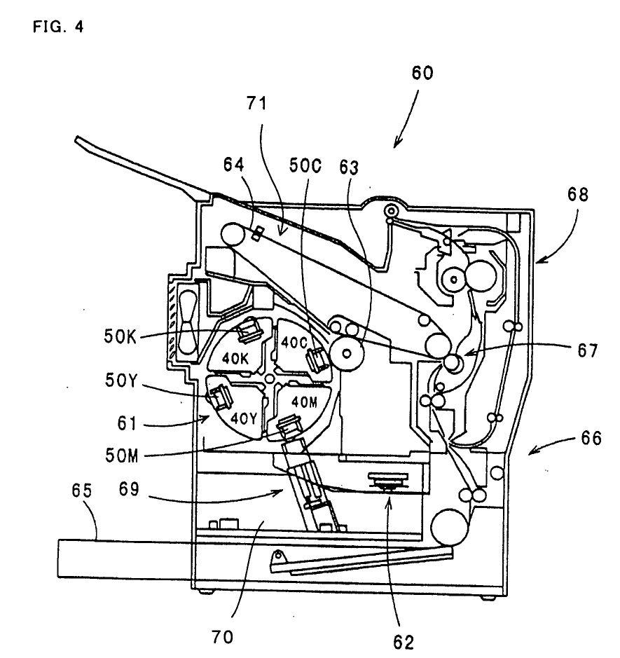

FIG. 4 schematically illustrates the structure of the color laser printer 60 functioning as an image formation apparatus in the embodiment of the invention. The color laser printer 60 is constructed as a full-color electrophotographic image formation apparatus that adopts a single photoreceptor system and an intermediate transfer system. As illustrated, color-separated images of four color components, cyan (C), magenta (M), yellow (Y), and black (K), are formed as electrostatic latent images on a photoreceptor 63 by means of an exposure unit 62 and are subsequently formed as color toner images corresponding to the electrostatic latent images with toners of the respective four colors supplied from four toner cartridges 40C, 40M, 40Y, and 40K attached to an image developer unit 61. The four color toner images are transferred first in an overlapping manner onto a transfer belt 64 as an intermediate transfer medium by a primary transfer unit 71. The overlapping four color toner images transferred onto the transfer belt 64 are further transferred by a secondary transfer unit 67 onto a sheet of printing paper, which is supplied from a paper cassette 65 and is fed by means of a feeder unit 66. The toner images transferred onto the printing paper are fused and fixed on the printing paper by a fixation unit 68. This forms a resulting color image on the printing paper. The image developer unit 61 is designed to be rotatable and to form the toner images of the respective colors on the photoreceptor 63. The color laser printer 60 of the embodiment also has a movable connector unit 69, which is connected with one of storage elements 50C, 50M, 50Y, and 50K of the respective toner cartridges 40C, 40M, 40Y, and 40K attached to the image developer unit 61, when the storage element 50C, 50M, 50Y, or 50K is located on a lower right side in the drawing. A controller 70 writes current pieces of setting information of the color laser printer 60 into the storage element 50 connecting therewith and reads existing pieces of information stored in the storage element 50. The electrical connection of the storage element 50 with the controller 70 is similar to that of the storage element 50 with the setting information management device 20 shown in FIG. 2 and is thus neither specifically described nor illustrated here.

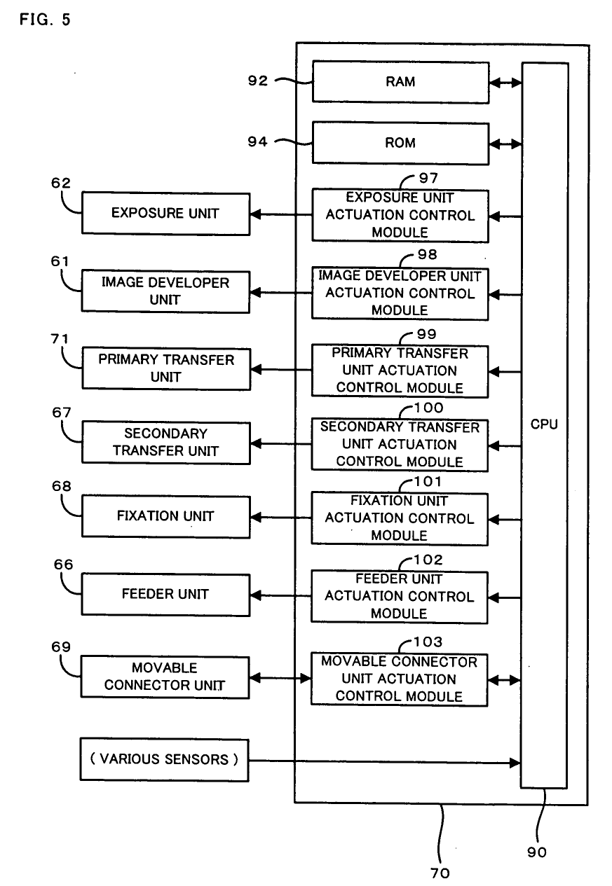

FIG. 5 is a block diagram showing functional blocks of the controller 70. As illustrated, the controller 70 is constructed as a microprocessor including a CPU 90, a RAM 92, and a ROM 94. The controller 70 receives measurement values of various sensors (for example, a temperature sensor) and other input signals (for example, a print instruction signal given by an operator) via signal lines. The controller 70 controls the operations of the respective constituents of the color laser printer 60, that is, the exposure unit 62, the image developer unit 61, the primary transfer unit 71, the secondary transfer unit 67, the fixation unit 68, the feeder unit 66, and the movable connector unit 69, based on these input signals via an exposure unit actuation control module 97, an image developer unit actuation control module 98, a primary transfer unit actuation control module 99, a secondary transfer unit actuation control module 100, a fixation unit actuation control module 101, a feeder unit actuation control module 102, and a movable connector unit actuation control module 103. The controller 70 writes the setting information of the color laser printer 60, which is input through operations of a non-illustrated operation panel of the color laser printer 60 or is input through operations of a computer connecting with the color laser printer 60, into the ROM 94 and controls the respective constituents of the color laser printer 60, based on the setting information.

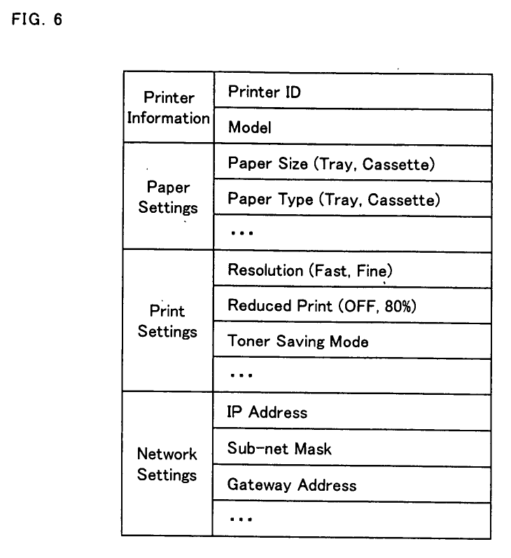

FIG. 6 shows one example of the information stored in the storage element 50 of the toner cartridge 40. In the structure of this embodiment, the setting information of the color laser printer 60, in addition to the ID (printer ID) and the model of the color laser printer 60, is stored in the storage element 50. The setting information of the color laser printer 60 includes, for example, information on paper settings (for example, paper size and paper type), print settings (for example, resolution, reduced print, and toner saving mode), and network settings (for example, IP address, sub-net mask, and gateway address). These pieces of information may be written into the storage element 50 by the controller 70 of the color laser printer 60 or according to a setting information output process executed by the setting information management device 20 of the embodiment as discussed later, at the moment when the toner cartridge 40 is detached from the color laser printer 60.

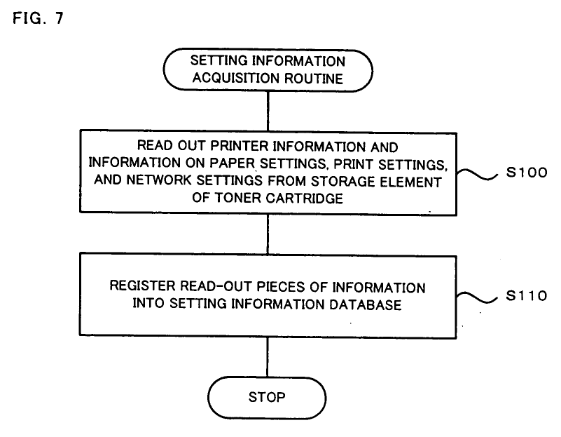

The setting information management device 20 of the embodiment operates as discussed below. FIG. 7 is a flowchart showing a setting information acquisition routine executed by the setting information management device 20 of the embodiment, when the collected toner cartridge 40 is set on the cartridge connector unit 28. When the setting information acquisition routine starts, the setting information management device 20 first reads out the printer information including the printer ID and the model, as well as the setting information of the color laser printer 60 including information on the paper settings, the print settings, and the network settings, from the storage element 50 of the toner cartridge 40 mounted thereon (step S100). This information reading step is triggered by output of a read signal from the computer main frame 22 to the read-write controller 54 included in the storage element 50 of the toner cartridge 40 set on the cartridge connector unit 28.

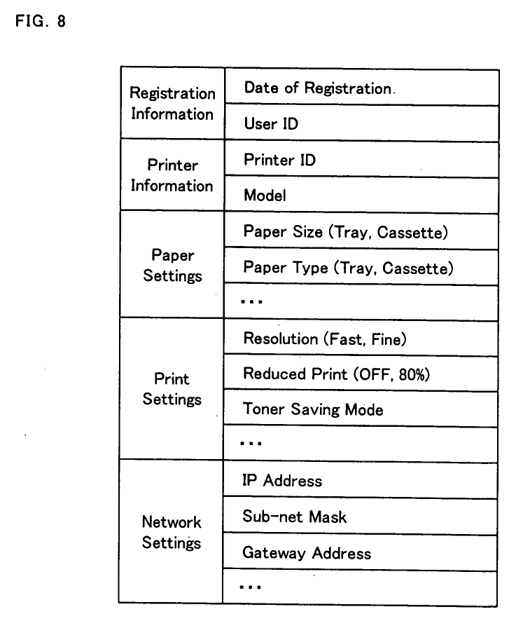

The setting information management device 20 then registers the read-out pieces of information into the setting information database 27 (step S110) and exits from the setting information acquisition routine. FIG. 8 shows one example of the information managed in the setting information database 27. The information managed in the setting information database 27 includes the date of execution of the setting information acquisition process (that is, the registration date), the ID allocated to the user of the color laser printer 60 (user ID), and the printer information and the setting information on the paper settings, print settings, and the network settings read at step S100. The user ID of the color laser printer 60 is independently input, for example, based on user registration information of the color laser printer 60.

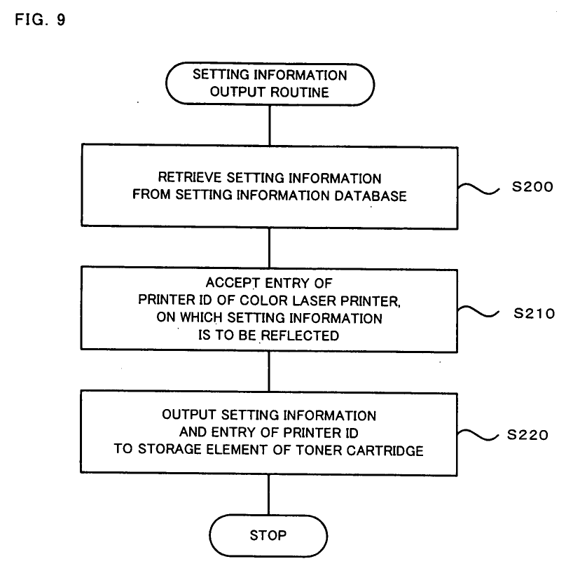

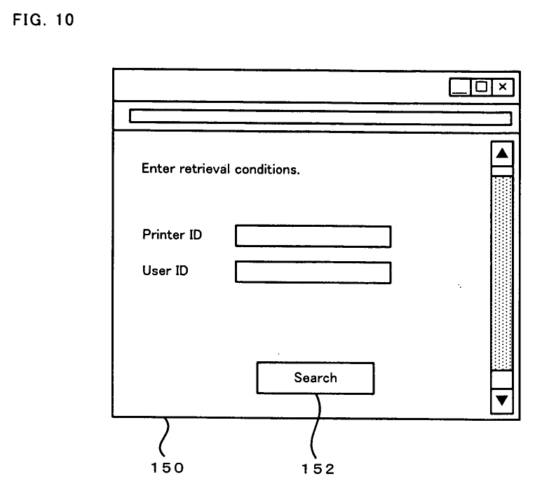

The following describes a setting information output process to output the setting information of the color laser printer 60 registered in the setting information database 27 into the storage element 50 of the toner cartridge 40. FIG. 9 is a flowchart showing a setting information output routine. When the setting information output routine starts, the setting information management device 20 first retrieves the setting information of the color laser printer 60, which is to be output to the storage element 50 of the toner cartridge 40, from the setting information database 27 (step S200). The concrete procedure of the embodiment outputs a setting information retrieval window 150 onto the monitor 26 and retrieves the setting information of the color laser printer 60 from the setting information database 27, based on retrieval conditions input on the setting information retrieval window 150. In the setting information retrieval window 150 shown in FIG. 10, the printer ID and the user ID are input as retrieval conditions. In response to a click of a Search button 152, a series of setting information satisfying the input retrieval conditions is retrieved among the setting information of the color laser printers 60 registered in the setting information database 27, based on the input retrieval conditions. For example, it is here assumed that the user replaces the color laser printer 60. The printer ID and the user ID of an old color laser printer 60 prior to replacement are used as the retrieval conditions, and the setting information to be reflected on a new color laser printer 60 after replacement is retrieved from the setting information database 27.

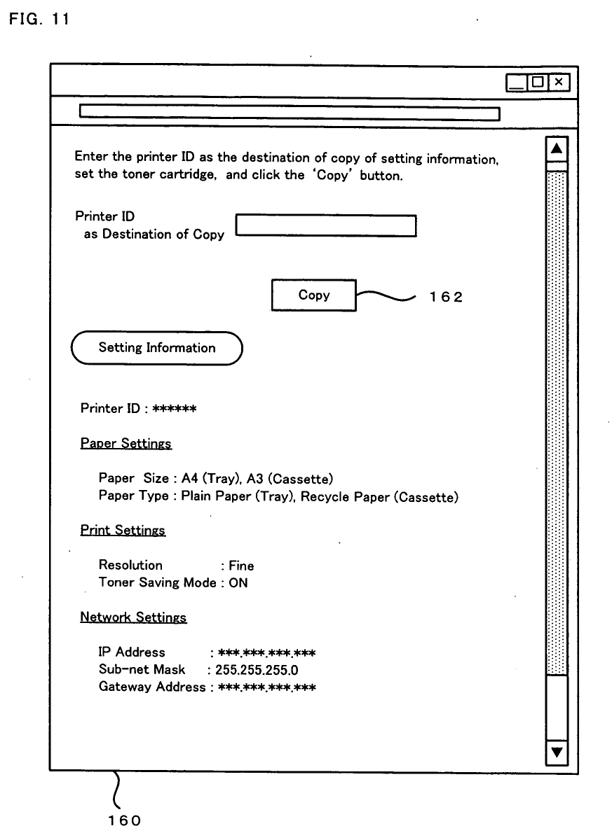

On completion of retrieval of the setting information of the color laser printer 60, the setting information management device 20 accepts an entry of the printer ID allocated to the color laser printer 60, on which the retrieved setting information is to be reflected (step S210). The concrete procedure of the embodiment outputs a printer ID entry window 160 on the monitor 26 and accepts the user's entry of the printer ID of the color laser printer 60 on the printer ID entry window 160. The printer ID entry window 160 shown in FIG. 11 has an input field for entry of the printer ID of the color laser printer 60, on which the setting information is to be reflected (the printer ID as the destination of copy), and a display field for showing the retrieved series of setting information. In the case of the replacement of the color laser printer 60 mentioned above, the printer ID to be entered as the destination of copy is the printer ID allocated to the new color laser printer 60 after replacement.

The setting information management device 20 stands ready until the operator of the setting information management device 20 sets the toner cartridge 40, which is to be attached to the color laser printer 60 as the object of reflection of the setting information, on the cartridge connector unit 28 and clicks a Copy button 162 on the printer ID entry window 160. In response to a click of the Copy button 162, the setting information management device 20 outputs the retrieved setting information and the entry of the printer ID as the destination of copy to the storage element 50 of the toner cartridge 40 set on the cartridge connector unit 28 (step S220) and exits from this setting information output routine. This information output step is triggered by output of a write signal from the computer main frame 22 to the read-write controller 54 included in the storage element 50.

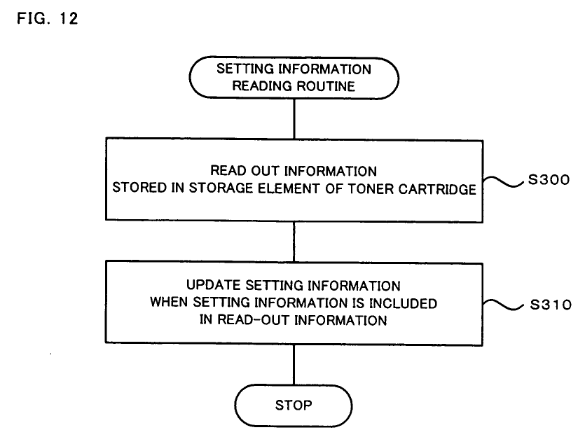

The following describes the operations of the color laser printer 60 of the embodiment and specifically an operation of reading the information stored in the storage element 50 of the toner cartridge 40. FIG. 12 is a flowchart showing a setting information reading routine executed by the controller 70 of the color laser printer 60 of the embodiment, when the toner cartridge 40 is attached to the color laser printer 60. When the setting information reading routine starts, the controller 70 first reads out the information stored in the storage element 50 connecting with the movable connector unit 69 via the movable connector unit actuation control module 103 (step S300). When the setting information of the color laser printer 60 is included in the read-out information, the controller 70 updates the setting information stored in the ROM 94 of the controller 70, based on the read-out setting information (step S310) and exits from this setting information reading routine. For example, in the case of attachment of the toner cartridge 40 having the storage element 50, to which the setting information of the color laser printer 60 and the printer ID as the destination of copy have been output according to the setting information output process by the setting information management device 20 of the embodiment, the setting information is reflected on the color laser printer 60 with the storage element 50 attached thereto. The procedure of this embodiment effectuates update of the setting information, only when the printer ID as the destination of copy stored in the storage element 50 is identical with the printer ID of the color laser printer 60. This arrangement effectively prevents the setting information from being reflected on any wrong color laser printer 60.

As described above, the setting information management device 20 of the embodiment reads the setting information of the color laser printer 60 from the storage element 50 of the toner cartridge 40 and outputs the read-out setting information to the storage element 50 of the toner cartridge 40. This arrangement enables the setting information of the color laser printer 60 to be readily copied. The color laser printer 60 of the embodiment reads out the setting information stored in the storage element 50 of the toner cartridge 40 and updates the setting information of the color laser printer 60. This arrangement ensures easy setting of the color laser printer 60.

In the setting information management device 20 of the embodiment, the CPU 23 that executes the setting information acquisition routine corresponds to the information acquisition module of the invention, while the CPU 23 that executes the setting information output routine corresponds to the information output module of the invention. In the color laser printer 60 of the embodiment, the controller 70 that executes the processing of step S300 corresponds to the information reading module of the invention, while the controller 70 that executes the processing of step S310 corresponds to the setting update module of the invention.

In the embodiment discussed above, the information on the paper settings (paper size and paper type), the print settings (resolution, reduced print, and toner saving mode), and the network settings (IP address, sub-net mask, and gateway address) is shown as the example of the setting information of the color laser printer 60 managed by the setting information management device 20. This is, however, only illustrative and not restrictive in any sense. Other pieces of information may be used as the setting information of the color laser printer 60.

The setting information management device 20 of the embodiment retrieves the setting information of the color laser printer 60 registered in the setting information database 27 and outputs the retrieved setting information to the storage element 50 of the toner cartridge 40. The information may be output in any other suitable form, as long as the output information effectuates setting of the color laser printer 60. One possible modification generates a setting program to attain setting of the color laser printer 60 based on the setting information of the color laser printer 60 registered in the setting information database 27, and outputs the setting program to the storage element 50. In this modified structure, when the toner cartridge 40 with the storage element 50 that stores the setting program therein is attached to the color laser printer 60, the color laser printer 60 executes the setting program to update the setting information.

In the setting information management device 20 of the embodiment, the setting information database 27, which is used for management of the information including the setting information of the color laser printer 60, is installed in the computer main frame 22. As long as the setting information database 27 is accessible, the setting information database 27 may be installed in another location, for example, in a computer connecting with the setting information management device 20 via a network.

In the structure of the embodiment, the setting information management device 20 includes the general-purpose computer main frame 22, the monitor 26, the setting information database 27, and the cartridge connector unit 28. Any computer device having an input-output interface with the storage element 50 of the toner cartridge 40 is applicable for the setting information management device 20. For example, the setting information management device may be a personal digital assistance driven with cells or a battery or an exclusive portable terminal having only the functions of the setting information management device. Such a terminal may be designed not to carry out registration of the setting information read from the storage element 50 into the setting information database 27 or retrieval of the setting information from the setting information database 27 but to directly output the read-out setting information.

The setting information management device 20 of the embodiment manages the setting information of the color laser printer 60, which is constructed as the full-color electrophotographic image formation apparatus adopting the single photoreceptor system and the intermediate transfer system. The requirement is that the toner cartridge 40 has the storage element 50 to store the setting information of the color laser printer 60 therein. The technique of the invention is thus applicable to manage setting information of color laser printers and color photocopiers constructed as full-color electrophotographic image formation apparatuses adopting a multi-photoreceptor system and a direct transfer system, as well as monochromatic laser printers and monochromatic photocopiers constructed as monochromatic electrophotographic image formation apparatuses. The invention is also applicable to manage setting information of ink jet printers.

In the above embodiment, the technique of the present invention is applied to the setting information management device 20 that reads and manages the setting information of the color laser printer 60 from the storage element 50 of the toner cartridge 40. The technique of the invention is also applicable to a setting information management method in relation to the setting information management device 20 of the embodiment. Another application is a program that causes single or multiple computers to function as the setting information management device of the embodiment.

In the case of such programs, the respective steps of the setting information acquisition routine shown in FIG. 7 and the setting information output routine shown in FIG. 9 may be programmed in a suitable programming language.

The above embodiment is to be considered in all aspects as illustrative and not restrictive. There may be many modifications, changes, and alterations without departing from the scope or spirit of the main characteristics of the present invention. All changes within the meaning and range of equivalency of the claims are therefore intended to be embraced therein.

What is claimed is:

1. A setting information management device that manages setting information of an image formation apparatus, which writes the setting information into a storage element of a recording material cartridge detachably and replaceably attached to said image formation apparatus, said setting information management device comprising:
an information acquisition module that acquires information including the setting information from said storage element of said recording material cartridge; and
an information output module that outputs reflecting information to a storage element of a recording material cartridge, which is attachable to another image formation apparatus of an identical model or a different model with or from the model of said image formation apparatus, based on the acquired setting information, where the reflecting information is used to reflect settings of said image formation apparatus on said another image formation apparatus of the identical model or the different model.

2. A setting information management device in accordance with claim 1, wherein the setting information includes at least one of network setting information, feeder setting information, resolution information, and toner saving mode information.

3. A setting information management device in accordance with claim 1, wherein the reflecting information represents the setting information acquired by said information acquisition module.

4. A setting information management device in accordance with claim 1, wherein the reflecting information represents a program executed to reflect the settings of said image formation apparatus on said another image formation apparatus of the identical model or the different model.

5. A setting information management device in accordance with claim 1, wherein said information output module outputs identification information, which identifies said another image formation apparatus of the identical model or the different model, in addition to the reflecting information, and
the reflecting information is used to reflect the settings of said image formation apparatus, when said recording material cartridge with said storage element, to which the reflecting information has been output, is attached to said another image formation apparatus identified by the identification information.

6. An image formation apparatus that forms an image on a recording medium, such as paper, with a recording material filled in a recording material cartridge detachably and replaceably attached to said image formation apparatus, said image formation apparatus comprising:
an information reading module that reads out information stored in a storage element of said recording material cartridge, when said recording material cartridge is attached to said image formation apparatus; and
a setting update module that, when the read-out information includes setting update information used to update settings of said image formation apparatus, updates the settings of said image formation apparatus, based on the setting update information.

7. An image formation apparatus in accordance with claim 6, wherein the setting update information represents information used to update at least one of settings including a network setting, a feeder setting, a resolution, and a toner saving mode.

8. An image formation apparatus in accordance with claim 6, wherein the setting update information includes, as a piece of information, identification information of an image formation apparatus, which is an object of update of its settings, and
said setting update module updates the settings of said image formation apparatus based on the setting update information, when the identification information included in the setting update information is identical with the identification information of said image formation apparatus.

9. An image formation apparatus in accordance with claim 6, said image formation apparatus further comprising:
an information writing module that writes the settings of said image formation apparatus as the setting update information into said storage element of said recording material cartridge.

10. A setting information management method that manages setting information of an image formation apparatus, which writes the setting information into a storage element of a recording material cartridge detachably and replaceably attached to said image formation apparatus, said setting information management method comprising the steps of:
(a) acquiring information including the setting information from said storage element of said recording material cartridge; and
(b) outputting reflecting information to a storage element of a recording material cartridge, which is attachable to another image formation apparatus of an identical model or a different model with or from the model of said image formation apparatus, based on the acquired setting information, where the reflecting information is used to reflect settings of said image formation apparatus on said another image formation apparatus of the identical model or the different model.

11. A setting information management method in accordance with claim 10, wherein the setting information includes at least one of network setting information, feeder setting information, resolution information, and toner saving mode information.

12. A setting information management method in accordance with claim 10, wherein the reflecting information represents the setting information acquired by said step(a).

13. A setting information management method in accordance with claim 10, wherein the reflecting information represents a program executed to reflect the settings of said image formation apparatus on said another image formation apparatus of the identical model or the different model.

14. A setting information management method in accordance with claim 10, wherein said step(b) outputs identification information, which identifies said another image formation apparatus of the identical model or the different model, in addition to the reflecting information, and
the reflecting information is used to reflect the settings of said image formation apparatus, when said recording material cartridge with said storage element, to which the reflecting information has been output, is attached to said another image formation apparatus identified by the identification information.
